(19) United States
(12) Patent Application Publication
(10) Pub. No.: US 2010/0014315 A1
(43) Pub. Date: Jan. 21, 2010

(54) LINEAR LIGHT SOURCE APPARATUS AND IMAGE READING APPARATUS PROVIDED WITH THE SAME

(75) Inventor: Hisayoshi Fujimoto, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD, Kyoto-shi (JP)

(21) Appl. No.: 12/528,489

(22) PCT Filed: Feb. 26, 2008
(86) PCT No.: PCT/JP2008/053227

§ 371 Date: Aug. 25, 2009

(30) Foreign Application Priority Data
Feb. 26, 2007 (JP) 2007-045938
Feb. 26, 2007 (JP) 2007-045939
Mar. 2, 2007 (JP) 2007-052492
Mar. 2, 2007 (JP) 2007-052552
Apr. 18, 2007 (JP) 2007-109099

(51) Int. Cl. F21V 7/04; F21V 7/22

(52) U.S. Cl. 362/615; 362/607; 362/609

(57) ABSTRACT

A linear light source apparatus (100) includes a light guide member (120) made of a transparent resin, and a light emitting element (200) for emitting light to the light guide member (120). The light guide member (120) includes a columnar main body (130), and a first end (121) and a second end (122) at two ends of the main body (130). The main body (130) includes a circumferential surface that is a smooth mirror surface and formed with a plurality of recesses (131) or projections (132) in a predetermined strip-shaped region extending in the longitudinal direction. The light emitted from the light emitting element (200) is emitted from a region of the main body (130), which faces the strip-shaped region, along the length of the main body (130). The recesses (131) or projections (132) extend straight in the width direction of the strip-shaped region.

### TECHNICAL FIELD

The present invention relates to a linear light source apparatus, and an image reading apparatus provided with the linear light source apparatus.

### BACKGROUND ART

Conventionally, linear light source apparatuses are used as a light source of an image reading apparatus designed to read a two-dimensional image of a document or a backlight of e.g. a liquid crystal display (see Patent Documents 1 and 2 identified below). FIG. 8 of the present application schematically illustrates the structure of an example of flatbed image scanner. The image scanner S includes an image sensor unit U in which a CCD line sensor 4 is mounted. The image sensor unit U further includes a light source 1, a plurality of mirrors 21-25 and a lens 3 which are accommodated in a case 5. The image sensor unit U is set to move under a transparent document supporting plate DP in the secondary scanning direction. In the operation, the document D is irradiated with light emitted from the light source 1, and the reflected light is then reflected by the mirrors 21-25 to converge on the CCD line sensor 4 via the lens 3.

Patent Document 1: JP-A-2000-134413

Patent Document 2: JP-A-11-146157

To read color images, the light source 1 of the image sensor unit U is designed to emit white light. Conventionally, a cold-cathode tube is used as the light source.

However, the use of a cold-cathode tube for the linear light source apparatus involves the following problems. Firstly, to drive a cold-cathode tube, the voltage needs to be increased using e.g. an inverter to produce a discharge, so that the cost for the power supply circuit is high. Secondly, a cold-cathode tube is not good for environment, because harmful mercury vapor is encapsulated in it. Thirdly, since a cold-cathode tube emits light in all directions around the axis, much light is wasted and the efficiency is not high.

### DISCLOSURE OF THE INVENTION

The present invention has been proposed under the circumstances described above. It is, therefore, an object of the present invention to provide a linear light source apparatus which can be replaced with a cold-cathode tube for use as the light source of e.g. an image reading apparatus incorporating a linear image sensor.

To solve the above-described problems, the present invention takes the following technical measures.

A linear light source apparatus provided according to a first aspect of the present invention includes a light guide member made of resin and a light emitting element arranged adjacent to the light guide member. The light guide member includes a columnar main body which is elongate in a direction and a first and a second ends at two ends of the main body. The main body includes a circumferential surface which is a smooth mirror surface and formed with a plurality of recesses or projections arranged in the longitudinal direction in a predetermined area in the circumferential direction. The light emitting element is e.g. an LED and arranged to face the first end of the light guide member. The light emitted from the light emitting element and entering the first end is emitted along the length of the main body from a region of the circumferential surface of the main body which faces the area in which the recesses or the projections are formed. The circumferential surface of the main body includes a strip-shaped region having a predetermined width and extending in the longitudinal direction of the main body, and the recesses or projections are formed in the strip-shaped region and extend straight in the width direction of the strip-shaped region.

A linear light source apparatus provided according to a second aspect of the present invention includes a light guide member including a first and a second cylindrical straight portions extending in parallel to each other at a predetermined distance and a connection portion connecting the first and the second straight portions to each other, and a light emitting unit arranged to face the ends of the first and the second straight portions. The first straight portion includes a circumferential surface that includes a first reflection region in the form of a strip formed with a plurality of recesses or projections, whereas the second straight portion includes a circumferential surface that includes a second reflection region in the form of a strip formed with a plurality of recesses or projections. Both of the first and the second reflection regions are positioned on one side of a reference plane that includes respective axes of the first and the second straight portions. In a cross section of the first and the second straight portions, a first straight line extending from the center of the first reflection region through the axis of the first straight portion and a second straight line extending from the center of the second reflection region through the axis of the second straight portion intersect at a point. Preferably, the light emitting unit includes two LEDs facing an end of the first straight portion and an end of the second straight portion, respectively, and a substrate to which both of the LEDs are mounted.

An image reading apparatus provided according to a third aspect of the present invention includes a light source apparatus for illuminating a linearly extending image reading region and an image sensor for detecting the light traveling from the image reading region. The light source apparatus is the linear light source apparatus provided according to the first or the second aspect of the present invention described above.

Other features and advantages of the present invention will become more apparent from the detailed description given below with reference to the accompanying drawings.

### BRIEF DESCRIPTION OF THE DRAWINGS

FIG. 1 shows the overall structure of a linear light source apparatus according to a first embodiment of the present invention.

FIG. 2 is a sectional view taken along lines II-II in FIG. 1.

FIG. 3 is a sectional view taken along lines III-III in FIG. 2.

FIG. 4 is an enlarged perspective view showing part of the light guide member shown in FIG. 1.

FIG. 5 is a sectional view showing a mold for making the light guide member.

FIG. 6 shows the overall structure of a linear light source apparatus according to a second embodiment of the present invention.

FIG. 7 is a partial sectional view showing a variation of the second embodiment.

FIG. 8 is a schematic view showing the structure of an image reading apparatus which utilizes a linear light source apparatus according to the present invention.

FIG. 9 shows the light path from a document to a CCD line sensor in the image reading apparatus.

FIG. 10 shows the overall structure of a linear light source apparatus according to a third embodiment of the present invention.

FIG. 11 is a sectional view taken along lines XI-XI in FIG. 10.

FIG. 12 shows the overall structure of a linear light source apparatus according to a fourth embodiment of the present invention.

FIG. 13 is a sectional view showing a principal portion of a linear light source apparatus according to a fifth embodiment of the present invention.

FIG. 14 is a sectional view taken along lines XIV-XIV in FIG. 13.

FIG. 15 shows the overall structure of a linear light source apparatus according to a sixth embodiment of the present invention.

FIG. 16 is a sectional view taken along lines XVI-XVI in FIG. 15.

FIG. 17 shows the overall structure of a linear light source apparatus according to a seventh embodiment of the present invention.

FIG. 18 is a sectional view showing a principal portion of a linear light source apparatus according to an eighth embodiment of the present invention.

FIG. 19 is a sectional view showing a principal portion of a linear light source apparatus according to a ninth embodiment of the present invention.

FIG. 20 is a plan view showing the overall structure of a linear light source apparatus according to a tenth embodiment of the present invention.

FIG. 21 is a back view showing the linear light source apparatus of the tenth embodiment.

FIG. 22 is a sectional view taken along lines XXII-XXII in FIG. 20.

FIG. 23 is a sectional view taken along lines XXIII-XXIII in FIG. 20.

FIG. 24 is a schematic view showing the structure of an image reading apparatus which utilizes the linear light source apparatus of the tenth embodiment.

FIG. 25 illustrates the advantages of the linear light source apparatus of the tenth embodiment.

### BEST MODE FOR CARRYING OUT THE INVENTION

Preferred embodiments of the present invention will be described below with reference to the accompanying drawings.

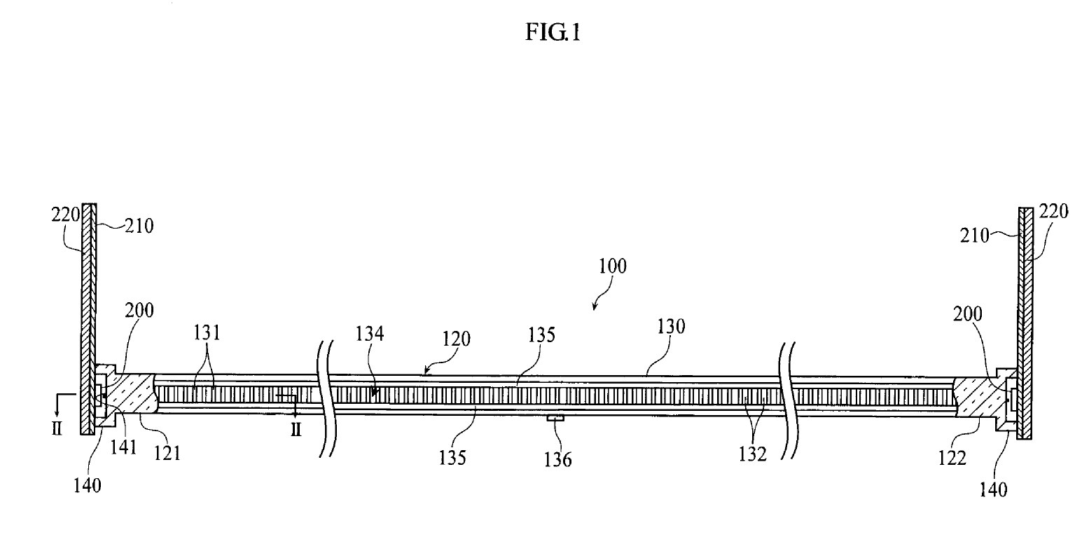

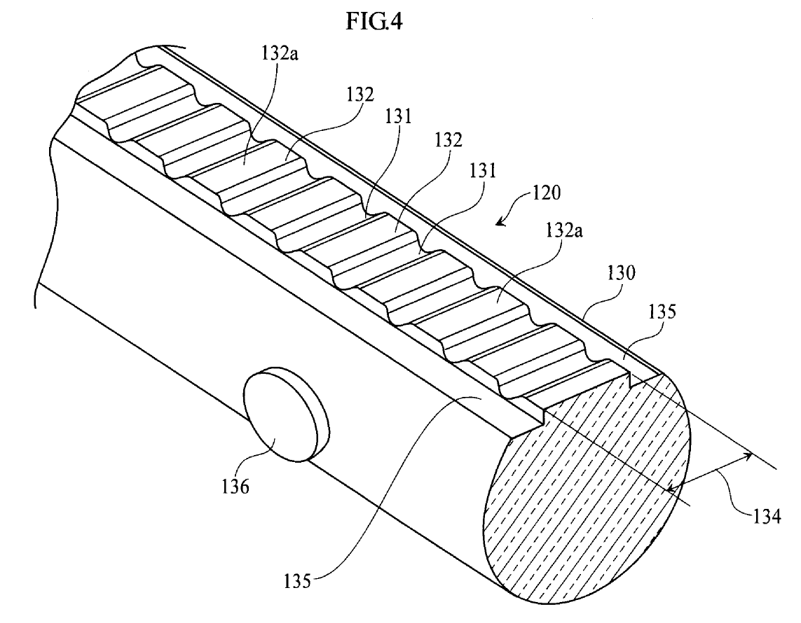

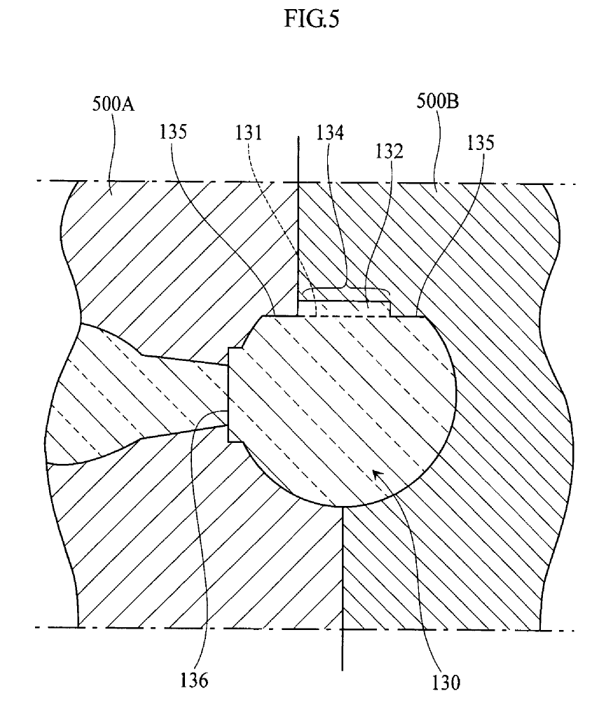

FIGS. 1-4 show a linear light source apparatus 100 according to a first embodiment of the present invention. The linear light source apparatus 100 includes a light guide member 120 which extends linearly and a light emitting element 200 arranged at each end of the light guide member 120.

As shown in FIG. 1, the light guide member 120 includes a cylindrical main body 130, and a first end 121 and a second end 122 integrally formed on the main body 130. The main body 130 has a uniform circular cross section throughout the length. The light guide member 120 is made of a transparent resin such as PMMA or polycarbonate. The main body 130 has a diameter of e.g. about 4 mm. The circumferential surface of the main body 130 is a smooth mirror surface.

As better shown in FIGS. 1, 2 and 4, the circumferential surface of the main body 130 includes a strip-shaped region 134 having a predetermined width and extending in the longitudinal direction of the main body 130. The strip-shaped region 134 is formed with a plurality of recesses 131 and projections 132 arranged alternately and continuously in the longitudinal direction. The upper surface 132a of each of the projections 132 is flat (i.e., straight in the width direction of the strip-shaped region 134). Each of the recesses 131 has a uniform cross section and extends in the width direction of the strip-shaped region 134. The bottom of each recess 131 is defined by a cylindrical inner surface, and the recess 131 is connected to the upper surface 132a of the projection 132 via a smooth cylindrical outer surface portion. The strip-shaped region 134 is flanked by flat portions 135 extending along the entire length of the strip-shaped region on two sides of the strip-shaped region which are spaced in the width direction. The flat portions 135 on the sides of the strip-shaped region 134 extend within a same plane and in parallel to the axis of the main body 130. While the diameter of the main body 130 is e.g. 4 mm as described before, the width of the strip-shaped region 134 is e.g. 1.6 mm, the width of each flat portion 135 is e.g. 0.35 mm, the height of the projections 132 relative to the flat portions 135 is e.g. 0.19 mm, the depth of the recesses 131 relative to the upper surface 132a of the projections 132 is e.g. 0.18 mm. The arrangement pitch of the recesses 131 is e.g. 1.5 mm. These dimensions can be varied depending on the diameter of the light guide member 120. In this embodiment, the recesses 131 and the projections 132 are formed to extend in the width direction of the strip-shaped region 134 to have a uniform cross section. Unlike this, however, recesses or projections having spherical surfaces may be formed at the surface of the strip-shaped region 134.

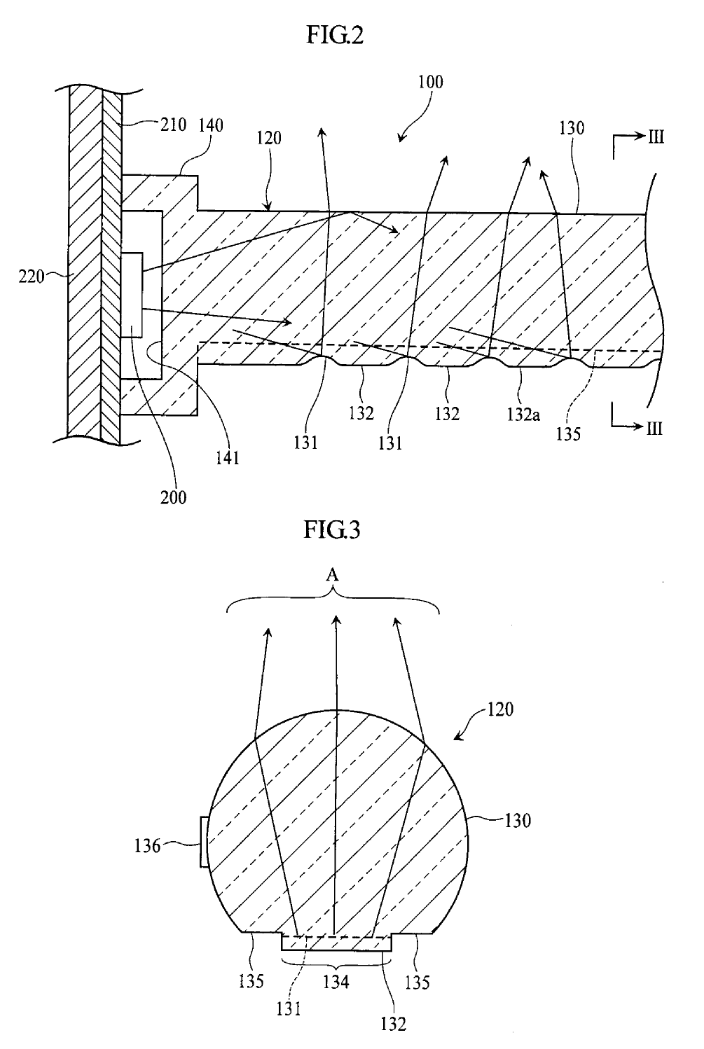

As shown in FIGS. 1 and 2, the first end 121 and the second end 122 of the light guide member 120 are integrally formed with angular socket portions 140. The bottom surface of each of the angular socket portions 140 substantially defines an end surface 141 of the main body. The end surface 141 serves as an incident portion through which the light emitted from the light emitting element 200 enters the main body 130.

As described before, the light guide member 120 is molded as a single-piece member by using a resin such as PMMA or polycarbonate. Specifically, as shown in FIG. 5, resin in a fluid state is injected into a cavity defined by a plurality of mold members 500A and 500B through a gate 136. After the resin is solidified, the mold is opened. In the light guide member 120, as shown in FIGS. 1, 3 and 4, the gate 136 is formed at the center of the main body 130 in the longitudinal direction. With respect to the circumferential direction of the main body 130, the gate 136 is provided at a position which avoids the strip-shaped region 134 formed with recesses 131 and projections 132 and a light emitting region facing the strip-shaped region 134. Specifically, the position of the gate 136 is deviated from the center of the width of the strip-shaped region 134 by substantially 90 degrees in the circumferential direction of the main body 130. The technical advantages of this arrangement will be described later.

As each of the light emitting elements 200, use may be made of a package-type white LED mounted on a substrate 210. Alternatively, however, LED bare chips of red (R), green (G) and blue (B) may be mounted on the substrate 210. The substrate 210 may be in the form of an elongated rectangle, and the light emitting element 200 is mounted at an end in the longitudinal direction. The other portions of the substrate are utilized for heat dissipation and arrangement of a wiring pattern. Preferably, the substrate 210 is made of aluminum nitride having high heat conductivity. To promote heat dissipation from the substrate 210, a heat dissipation plate 220 made of an aluminum or aluminum alloy and having a predetermined thickness is bonded in a laminated manner to the reverse surface of the substrate 210.

The substrates 210 are connected to the first end 121 and the second end 122 of the light guide member 120, respectively. Specifically, each substrate 210 and a respective one of the socket portions 140 are bonded together by using e.g. an adhesive so that the light emitting element 200 is accommodated in the socket portion 140.

The advantages of the linear light source apparatus 100 having the above-described structure are described below.

When the light emitting element 200 is turned on at each of the two ends 121, 122 of the light guide member 120, the light emitted from the light emitting element 200 impinges on the end surface 141 of the main body 130 from the first end 121 or the second end 122 (see FIG. 2). As schematically shown in FIG. 2, the light entering the main body 130 travels in the main body 130 in the longitudinal direction while being totally reflected at the smooth surface. As schematically shown in FIG. 2, part of the light is reflected at the recesses 131, and hence, changes the travel direction to a direction crossing the main body 130. The recesses 131 extend straight in the width direction of the strip-shaped region 134. Thus, the light reflected at the recesses 131 travels to cross the main body 130 without spreading. As schematically shown in FIG. 3, after the travel direction is changed, the light travels in the main body 130 substantially toward a region facing the strip-shaped region 134 formed with the recesses 131 and the projections 132. Of the light, the light rays which impinge on the circumferential surface of this region of the main body 130 at an angle smaller than the critical angle for total reflection are emitted to the outside. The convex lens effect is provided by the cylindrical shape of the main body 130, i.e., the fact that the main body 130 has a cylindrical outer surface except at the strip-shaped region 134 (the region formed with the recesses 131 and the projections 132) and the flat portions 135 on each side. Thus, the light is prevented from spreading in the circumferential direction of the main body 130 in exiting, so that the emitting light converges on a target region A.

The strip-shaped region 134 of the main body 130, which is formed with the recesses 131 and the projections 132, is formed to be sandwiched between flat portions 135. Thus, although the main body 130 has a substantially cylindrical outer configuration, it is easy to make the width of the strip-shaped region 134 uniform throughout the length of the main body 130. Thus, when the light traveling in the longitudinal direction of the light guide member 120 changes the travel direction and exits the light guide member from the outer surface facing the strip-shaped region 134, the light is emitted uniformly from every point of the main body 130 in the longitudinal direction. Moreover, the recesses 131 and the projections 132 are formed at the strip-shaped region 134 of the main body 130 to extend straight in the width direction of the strip-shaped region 134. Thus, in preparing mold members 500A and 500B to mold the light guide member 120 which have a separate structure as shown in FIG. 5, the formation of the inner surface of the mold which is suitable for forming the recesses 131 and the projections 132 is easy.

In the light guide member 120, with respect to the circumferential direction of the main body 130, the gate 136 of molding is formed at a position which avoids the strip-shaped region 134 and the light emitting region facing the strip-shaped region 134, and specifically, at a position deviated from the center of the width of the strip-shaped region 134 by substantially 90 degrees in the circumferential direction of the main body 130. Thus, although the presence of the gate 136 causes the shape variation and shade in the light guide member, the change of the light travel direction due to the recesses 131 and the projections 132 and the light emission through the surface of the main body 130 are not hindered at part of the light guide member. Further, the position of the gate 136 is substantially at the center in the longitudinal direction of the main body 130. That is, the gate 136 is provided at the farthest position from both of the first end 121 and the second end 122, through which the light from the light emitting elements 200 enters the light guide member 120. Thus, the adverse effect of the shape variation and shade due to the presence of the gate 136 is minimized.

In the linear light source apparatus 100, the substrate 210 on which the light emitting element 200 is to be mounted is made of aluminum nitride. Further, the substrate 210 includes a portion for heat dissipation in addition to the portion for mounting the light emitting element 200. Moreover, a heat dissipation plate 220 made of aluminum or aluminum alloy is bonded in a laminated manner to the reverse surface of the substrate 210. With this arrangement, the heat generated in lighting the light emitting element 200 is efficiently dissipated to the outside. Thus, lighting of the light emitting element 200 with a high output for a long time is possible, so that a linear light source with high light emission efficiency is provided.

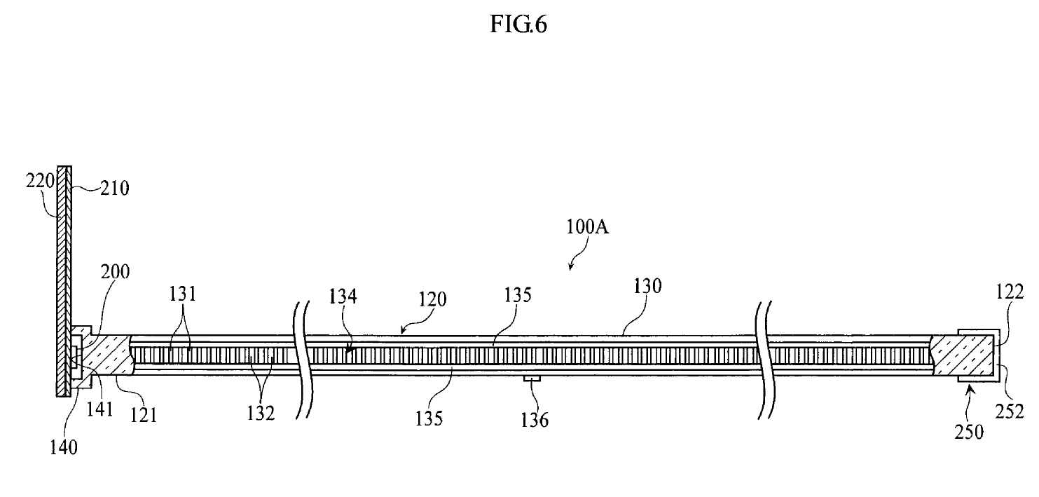

FIG. 6 shows a linear light source apparatus according to a second embodiment of the present invention. The linear light source apparatus 100A differs from that of the first embodiment shown in FIGS. 1-4 in that a light emitting element 200 is arranged at an end (first end) 121 of the light guide member 120 and a reflector 250 is arranged at the other end (second end) 122 of the light guide member. As to the linear light source apparatus 100A of the second embodiment, only the portions which are different from those of the linear light source apparatus 100 of the first embodiment are described below. The portions which are identical or similar to those of the linear light source apparatus 100 of the first embodiment are designated by the same reference signs as those used for the first embodiment, and the description is omitted appropriately.

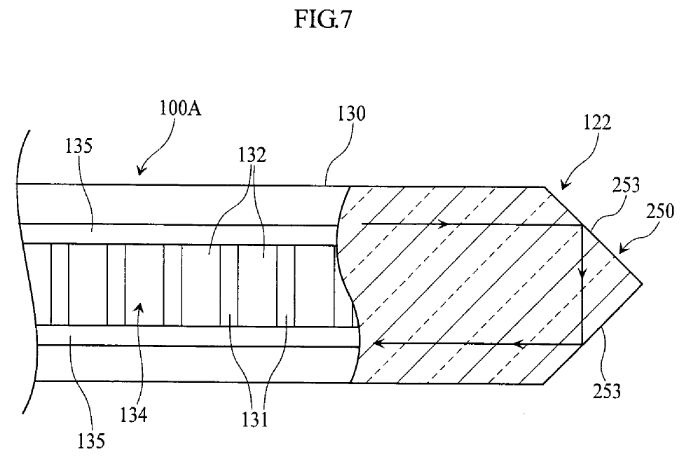

The light guide member 120 is formed with a socket portion 140 only at the first end 121 of the main body 130. The reflector 250 is provided at the second end 122. The configuration of the main body 130 and the socket portion 140 is basically the same as that of the first embodiment. The reflector 250 may be provided by fitting a cap 252 made of a resin which is white or close to white to the second end 122 of the main body 130 or by vapor deposition of a metal. Alternatively, the reflector may be provided by cutting the second end 122 of the light guide member 120 into a triangular mountain made up of two surfaces inclined 45 degrees with respect to the axis of the main body 130 as shown in FIG. 7 or cutting the second end into a conical or pyramidal shape of which generatrix or ridge line is inclined about 45 degrees with respect to the axis of the main body 130. With this arrangement, a large proportion of the light traveling in the main body 130 in the axial direction is totally reflected twice by the inclined surfaces 253 of the second end 122 to return. The returning light further changes the travel direction due to the reflection at the recesses 131 and the projections 132 in the strip-shaped region 134, and hence, is utilized efficiently as emitting light.

The arrangement of other portions is basically the same as that of the first embodiment. That is, the light emitting element 200 is mounted to the substrate 210 and arranged to face the first end 121 of the light guide member 120 via the socket portion 140. The main body 130 of the light guide member 120 is formed with a strip-shaped region 134 flanked by flat portions 135, and the strip-shaped region is formed with recesses 131 and projections 132. The position of the resin-molding gate 136 in the circumferential direction of the main body 130 is deviated relative to the strip-shaped region 134 by substantially 90 degrees in the circumferential direction.

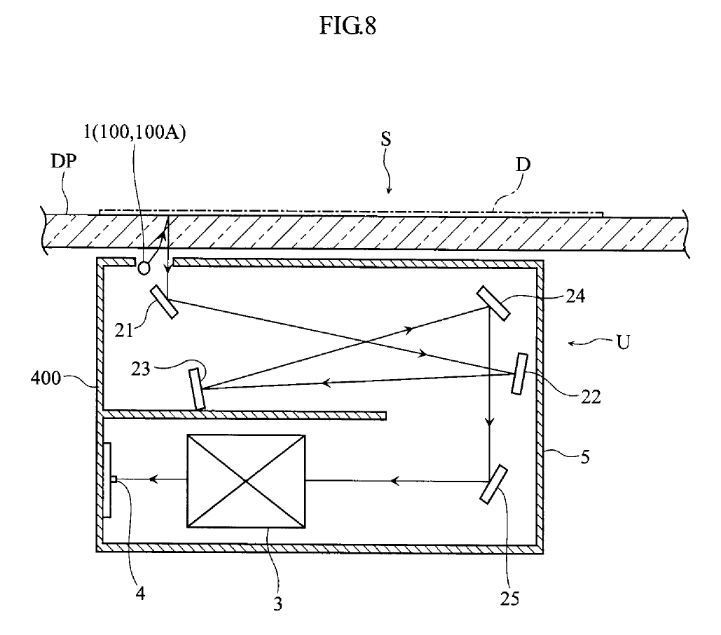

The linear light source apparatus 100, 100A having the above-described structure is suitably used, instead of a conventional cold-cathode tube, as the light source of an image reading apparatus 400 which may be a CCD image sensor unit. As shown in FIG. 8, the image reading apparatus 400 includes the linear light source apparatus 100 (100A), a plurality of mirrors 21-25, a lens 3, and a CCD line sensor 4, which are accommodated in a case 5. In a flatbed image scanner S, the image reading apparatus is set to move under a document supporting plate DP, which is made of e.g. transparent glass, in the secondary scanning direction. In the operation, the document D is irradiated with light emitted from the linear light source apparatus 100 (100A). The light reflected at the document is reflected by the mirrors 21-25 and then converges on the CCD line sensor 4 via the lens 3. An image of one line of the document D which extends in the primary scanning direction is formed on and read by the CCD line sensor 4. By repeating this operation each time the image reading apparatus 400 moves in the secondary scanning direction by a predetermined pitch, the two-dimensional image of the document is read.

As noted before, in the linear light source apparatus 100 (100A) having the above-described structure, the main body 130 of the light guide member, which is the light emitting portion, is cylindrical. Thus, the linear light source apparatus is easily incorporated in the image reading apparatus 400 at a portion designed to hold a cold-cathode tube without making considerable design change. The linear light source apparatus 100 (100A) efficiently emits light from a circumferential surface portion of the main body 130 of the light guide member 120 which faces the strip-shaped region 134 in a limited direction (see FIG. 3). The linear light source apparatus is so mounted in the flatbed image scanner S that the light emission is directed to a predetermined region in the secondary scanning direction of a document D on the document supporting plate DP. With this arrangement, unlike a cold-cathode tube which emits light from the entire circumferential surface, the light from the linear light source apparatus 100 (100A) is directed in a desired limited direction throughout the entire length without the need for using an additional reflector.

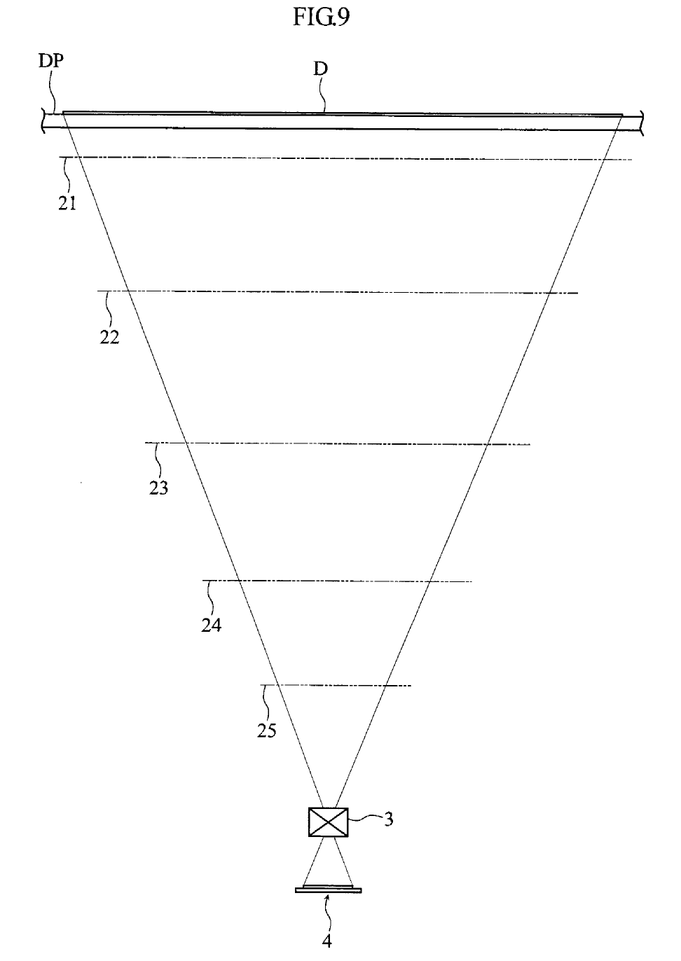

FIG. 9 schematically illustrates the light path in a CCD image sensor unit. Specifically, this figure shows the light path, as developed, which is folded by the mirrors 21-25 in the process of traveling from the document D to the CCD line sensor 4 via the lens 3. As will be understood from the figure, the angle of view of the reading width of the document D viewed from the side of the CCD line sensor 4 or the lens 3 spreads to be about 50°. This indicates that the light path extending from an end of the reading width of the document to the CCD line sensor 4 is longer than the length of the light path extending from the center of the reading width to the CCD line sensor 4. Thus, when the document D is irradiated with light of a uniform brightness throughout the entire reading width, the image read by the CCD line sensor 4 is darker at a portion closer to an end of the reading width.

In the linear light source apparatus 100 (10A), however, a larger amount of light can be emitted from the two ends of the light guide member 120 than from the center of the light guide member in the longitudinal direction (corresponding to the primary scanning direction). This can be achieved by making the arrangement pitch of the recesses 131 shorter as proceeding from the center toward each end of the light guide member 120 in the longitudinal direction, i.e., by increasing the density of the recesses 131 as proceeding toward each end. This arrangement ensures that the image read by the CCD line sensor 4 has a uniform brightness in the primary scanning direction.

Conventionally, a cold-cathode tube is employed as a backlight source of this kind of flat display. However, the cold-cathode tube can be replaced with the linear light source apparatus having the above-described structure.

Although the main body 130 of the light guide member 120 is cylindrical in the foregoing embodiments, the main body may have other columnar shapes. For instance, the main body may be in the form of an elliptical cylinder. However, it is preferable that the outer surface of the main body does not include a clear ridge line except at the strip-shaped region 134 and the flat portions 135 sandwiching the strip-shaped region.

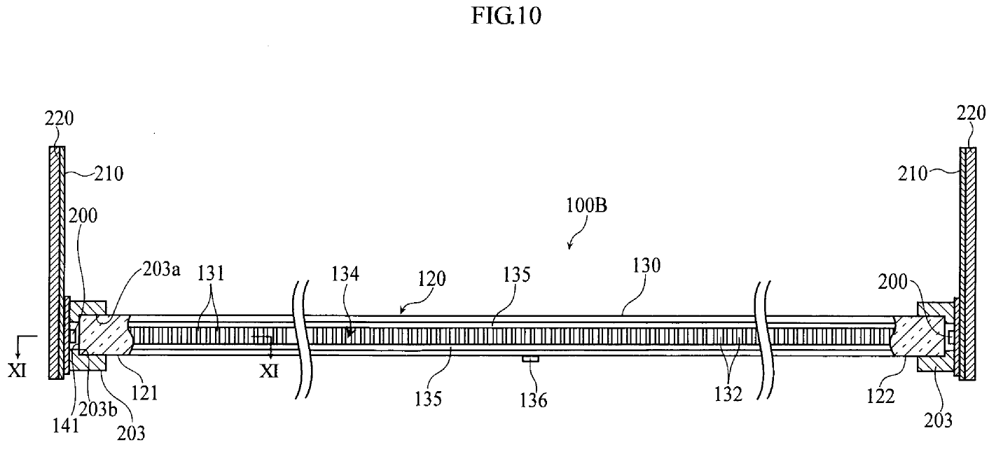

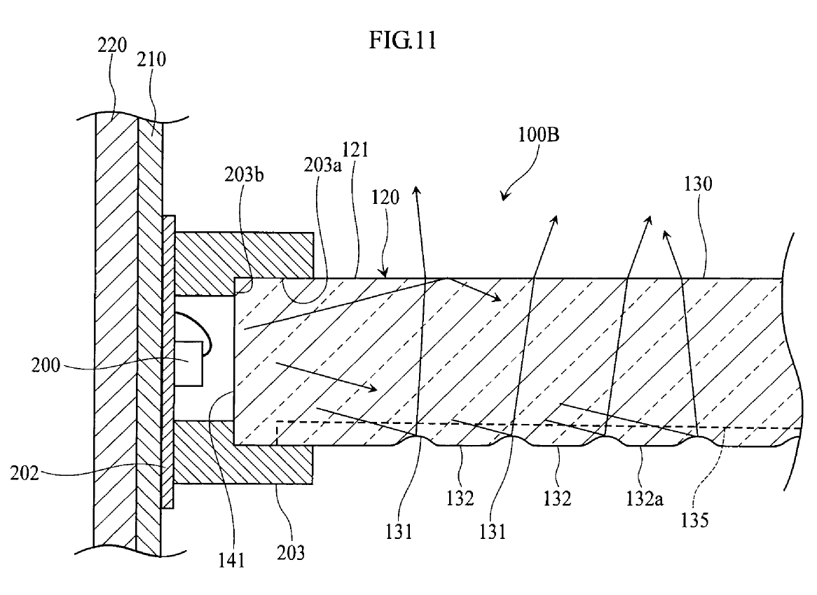

FIGS. 10 and 11 show a linear light source apparatus 100B according to a third embodiment of the present invention. Similarly to the first embodiment, the linear light source apparatus 100B includes a light guide member 120 and a light emitting element 200 arranged at each end of the light guide member 120. The basic structure of the linear light source apparatus 100B of the third embodiment is substantially the same as that of the linear light source apparatus 100 of the first embodiment. However, the light guide member 120 of this embodiment is fixed to the substrates 210 in a manner different from the first embodiment, as described below.

As shown in FIG. 10, the light guide member 120 includes a cylindrical main body 130 having a uniform circular cross section throughout the length, and a first end 121 and a second end 122 formed on the main body 130. The light guide member is molded as a single-piece member by using a transparent resin such as PMMA or polycarbonate. The cylindrical main body 130 has a diameter of e.g. about 2 mm. The circumferential surface of the main body 130 is a smooth mirror surface.

As better shown in FIGS. 10 and 11, the circumferential surface of the main body 130 includes a strip-shaped region 134 having a predetermined width and extending in the longitudinal direction of the main body 130. The strip-shaped region 134 is formed with a plurality of recesses 131 and projections 132 arranged alternately and continuously in the longitudinal direction. The strip-shaped region 134 is flanked by flat portions 135 extending along the entire length of the strip-shaped region on two sides of the strip-shaped region which are spaced in the width direction. The flat portions 135 on the sides of the strip-shaped region 134 extend within a same plane and in parallel to the axis of the main body 130. While the diameter of the main body 130 is e.g. 2 mm as described before, the width of the strip-shaped region 134 is e.g. 0.8 mm, the width of each flat portion 135 is e.g. 0.175 mm, the height of the projections 132 relative to the flat portions 135 is e.g. 0.13 mm, the depth of the recesses 131 relative to the upper surface 132a of the projections 132 is e.g. 0.12 mm. The arrangement pitch of the recesses 131 is e.g. 1.5 mm. These dimensions can be varied depending on the diameter of the light guide member 120.

The light guide member 120 can be formed by the molding technique described with respect to the first embodiment with reference to FIG. 5. Specifically, resin in a fluid state is injected into a cavity defined by a plurality of mold members (see the reference signs 500A and 500B in FIG. 5) through a gate (see the reference sign 136 in FIG. 5). After the resin is solidified, the mold is opened. As shown in FIG. 10, in the light guide member 120 of the third embodiment again, the gate 136 is formed at the center of the main body 130 in the longitudinal direction. With respect to the circumferential direction of the main body 130, the gate 136 is provided at a position which avoids the strip-shaped region 134 formed with recesses 131 and projections 132 and a light emitting region facing the strip-shaped region 134. Specifically, the position of the gate 136 is deviated from the center of the width of the strip-shaped region 134 by substantially 90 degrees in the circumferential direction of the main body 130.

As each of the light emitting elements 200, use is made of a package-type LED. As shown in FIG. 11, the light emitting element 200 is mounted on an auxiliary substrate 202, and the auxiliary substrate 202 is fixed to a substrate 210. That is, the light emitting element 200 is mounted to the substrate 210 via the auxiliary substrate 202. As shown in the figure, a frame-shaped connection member 203 is fixed to the auxiliary substrate 202. The frame-shaped connection member 203 is formed with a through-hole 203a, and the light emitting element 200 is arranged in the through-hole 203a. Preferably, the frame-shaped connection member 203 is made of a white resin. The through-hole is circular and formed with a stepped portion 203b at a predetermined depth position. Thus, the through-hole 203a is made up of a first accommodation portion having a relatively large inner diameter and a second accommodation portion communicating with the first accommodation portion and having a relatively small inner diameter. The inner diameter of the first accommodation portion corresponds to the outer diameter of the light guide member 120 and is about 2 mm in the illustrated example. The distance (height) of the stepped portion 203b from the surface of the auxiliary substrate 202 is made sufficiently larger than the height of the light emitting element 200 so that the light emitting element 200 is accommodated in the second accommodation portion with space. The light emitting element 200 may be designed to emit blue light. The second accommodation portion of the through-hole 203a (i.e., the portion extending to the stepped portion 203b) is filled with resin (not shown) to cover the light emitting element 200. A fluorescent material may be applied to the surface of the resin to convert the blue light into e.g. white light.

Each of the light emitting elements 200 is mounted to the substrate 210 in the above-described manner. Each end of the light guide member 120 is inserted into the through-hole 203a of the corresponding frame-shaped connection member 203 until the end surface abuts on the stepped portion 203b. With this arrangement, the light emitting elements 200a properly face the first and the second ends 121 and 122 of the light guide member 120, respectively, and the substrates 210 are properly connected to the first and the second ends 121 and 122 of the light guide member 120, respectively.

Each of the substrates 210 may be in the form of an elongated rectangle, and the light emitting element 200 is mounted at an end in the longitudinal direction. The other portions of the substrate are utilized for heat dissipation and arrangement of a wiring pattern. The substrate 210 is made of e.g. aluminum nitride having high heat conductivity. To promote heat dissipation from the substrate 210, a heat dissipation plate 220 made of an aluminum or aluminum alloy and having a predetermined thickness is bonded in a laminated manner to the reverse surface of the substrate 210. As a means to promote heat dissipation, a layer having a high surface thermal radiation rate may be formed on part or the entirety of the exposed surface of the heat dissipation plate 220. The layer may be formed by applying a black paint on the exposed surface, coating the exposed surface with a ceramic material having a high thermal radiation rate or bonding a sheet made of a material having a high thermal radiation rate. Alternatively, surface treatment such as the “GHA processing” provided by SANKEI SEIKI CO., LTD may be performed.

The advantages of the linear light source apparatus 100B having the above-described structure are described below.

As shown in FIG. 11, the light emitted from the light emitting element 200 impinges on the end surface 141 of the first end 121 or the second end 122 of the light guide member 120. As schematically shown in the figure, the light entering the main body 130 in this way travels in the main body 130 in the longitudinal direction while being totally reflected at the smooth surface. Part of the light is reflected at the recesses 131, and hence, changes the travel direction to a direction crossing the main body 130. The recesses 131 extend straight in the width direction of the strip-shaped region 134. Thus, the light reflected at the recesses 131 travels to cross the main body 130 without spreading. After the travel direction is changed, the light travels in the main body 130 toward a region facing the strip-shaped region 134 formed with the recesses 131 and the projections 132. Of the light, the light rays which impinge on the circumferential surface of this region of the main body 130 at an angle smaller than the critical angle for total reflection are emitted to the outside. Since the main body 130 is cylindrical, i.e., the main body 130 has a cylindrical outer surface except at the strip-shaped region 134 (the portion formed with the recesses 131 and the projections 132) and the flat portions 135 on each side, the light is prevented from spreading in the circumferential direction of the main body 130 in exiting (convex lens effect). Thus, the light converges on a target region.

The strip-shaped region 134 of the main body 130, which is formed with the recesses 131 and the projections 132, is formed to be sandwiched between flat portions 135. Thus, although the main body 130 has a substantially cylindrical outer configuration, it is easy to make the width of the strip-shaped region 134 uniform throughout the length of the main body 130. Thus, when the light traveling in the longitudinal direction of the light guide member 120 changes the travel direction and exits the light guide member from the outer surface facing the strip-shaped region 134, the light is emitted uniformly from every point of the main body 130 in the longitudinal direction.

Each end of the light guide member 120 faces the light emitting element 200 while being received in the through-hole 203a of the frame-shaped connection member 203. The frame-shaped connection member 203 is made of a resin which is white or close to white. With this arrangement, most of the light emitted from the light emitting element 200 properly impinges on the first or the second end 1221, 122 of the light guide member 120 without being wasted.

The through-hole 203a of the frame-shaped connection member 203 has a circular shape corresponding to the cross sectional configuration of the light guide member 120. Thus, the light guide member 120 can be connected to the frame-shaped connection member 203 with a desired orientation by turning around the axis. Thus, the position of the recesses 131 or the projections 132 of the light guide member 120 relative to the substrate 210 in the circumferential direction can be set as desired.

In the linear light source apparatus 100B, the substrate 210 on which the light emitting element 200 is to be mounted is made of aluminum nitride. Further, a heat dissipation plate 220 made of aluminum or aluminum alloy is bonded in a laminated manner to the reverse surface of the substrate 210. With this arrangement, the heat generated in lighting the light emitting element 200 is efficiently dissipated to the outside. Thus, lighting of the light emitting element 200 with a high output for a long time is possible.

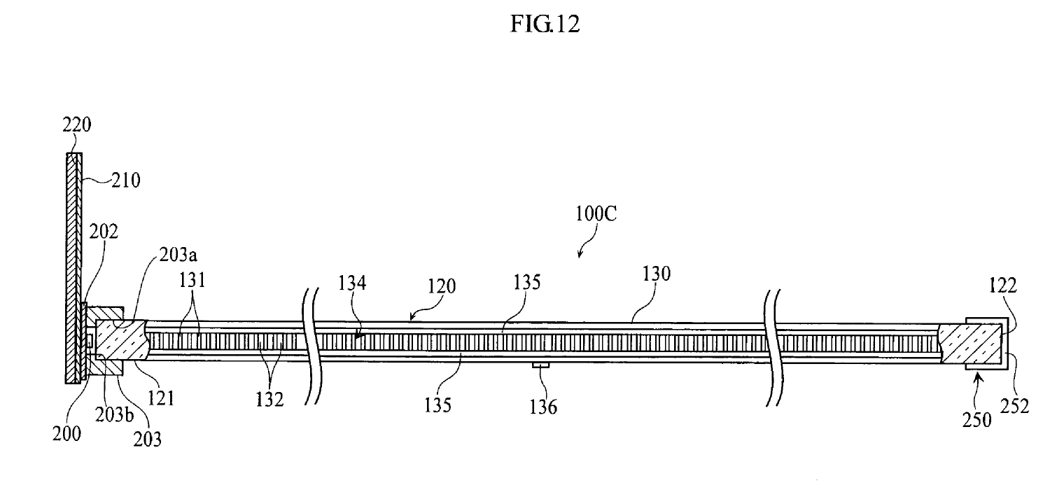

FIG. 12 shows a linear light source apparatus according to a fourth embodiment of the present invention. The linear light source apparatus 100C differs from the linear light source apparatus 100B of the third embodiment shown in 10 in that a light emitting element 200 is arranged at an end (first end) 121 of the light guide member 120 and a reflector 250 is arranged at the other end (second end) 122 of the light guide member. As to the linear light source apparatus 100C, only the portions which are different from those of the linear light source apparatus 100B of the third embodiment are described below. The description of the portions which are identical or similar to those of the third embodiment is omitted appropriately.

The arrangement of this embodiment includes a single light emitting element 200, which is arranged to face the first end 121 of the main body 130 of the light guide member 120. The reflector 250 is provided at the second end 122. The configuration of the main body 130 and the connection structure of the first end 121 and the substrate 210 are basically the same as that of the third embodiment. The reflector 250 may be provided by fitting a cap 252 made of a resin which is white or close to white to the second end 122 of the main body 130 or by vapor deposition of a metal. Alternatively, the reflector may be provided by cutting the second end 122 of the light guide member 120 into a triangular mountain made up of two surfaces inclined 45 degrees with respect to the axis of the main body 130, as described with reference to FIG. 7. Alternatively, the reflector may be provided by cutting the second end into a conical or pyramidal shape of which generatrix or ridge line is inclined about 45 degrees with respect to the axis of the main body 130. With this arrangement, a large proportion of the light traveling in the main body 130 in the axial direction is totally reflected twice by the inclined surfaces 253 of the second end 122 to return. The returning light further changes the travel direction due to the reflection at the recesses 131 and the projections 132 in the strip-shaped region 134, and hence, is utilized efficiently as emitting light.

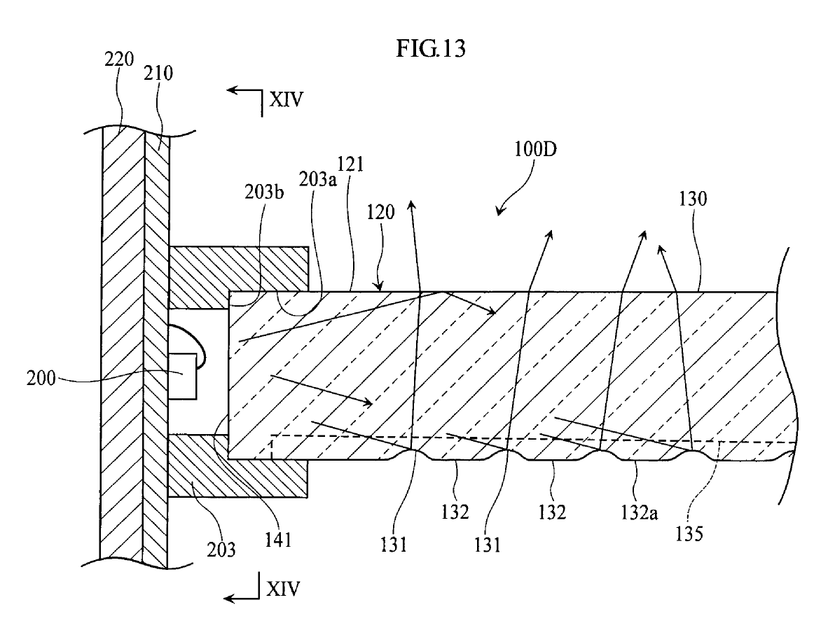

FIG. 13 shows a linear light source apparatus according to a fifth embodiment of the present invention. The linear light source apparatus 100D differs from the linear light source apparatus 100B, 100C of the third or the fourth embodiment in that the light emitting element 200 is directly bonded to the substrate 210 and the frame-shaped connection member 203 is fixed to the substrate 210. The substrate 210 made of aluminum nitride is formed with a bonding pad (not shown), and the light emitting element 200 is directly bonded to the pad. The terminal on the top surface of the light emitting element 200 is connected to an electrode pattern formed on the substrate 210 via a wire.

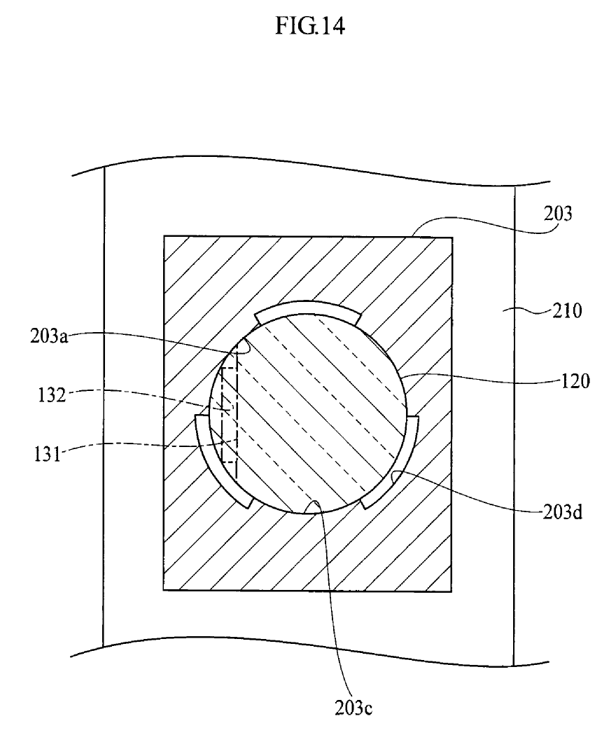

Although the end of the light guide member 120 is made cylindrical and the through-hole 203a of the frame-shaped connection member 203 is correspondingly made cylindrical in the third through the fifth embodiments, the present invention is not limited to this. For instance, as shown in FIG. 14, the frame-shaped connection member 203 may include a cylindrical inner surface portion 203c and a recess 203d retreated from the cylindrical inner surface portion 203c. With this arrangement, after the light guide member 120 is appropriately turned around the axis for a desired orientation, the light guide member can be reliably and firmly fixed to the frame-shaped connection member 203 by loading e.g. an adhesive into the recess 203d.

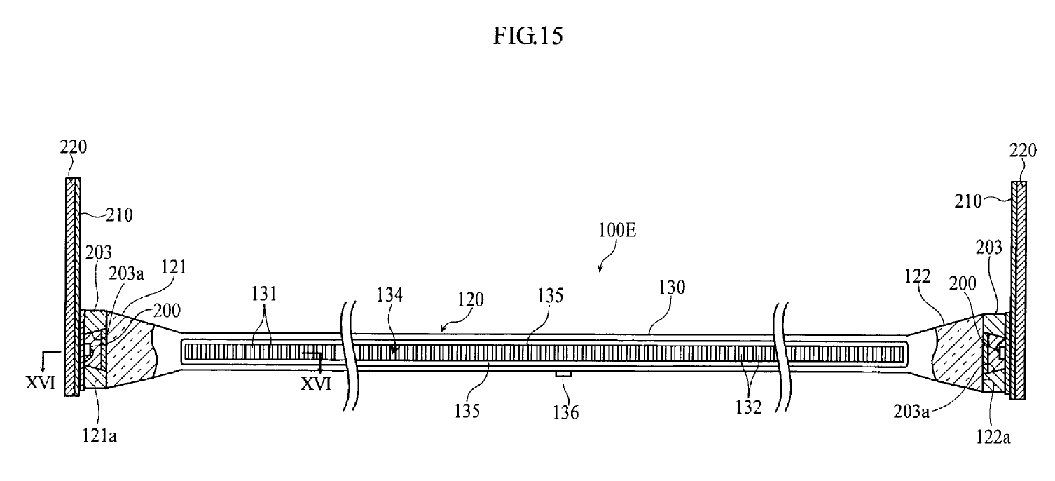

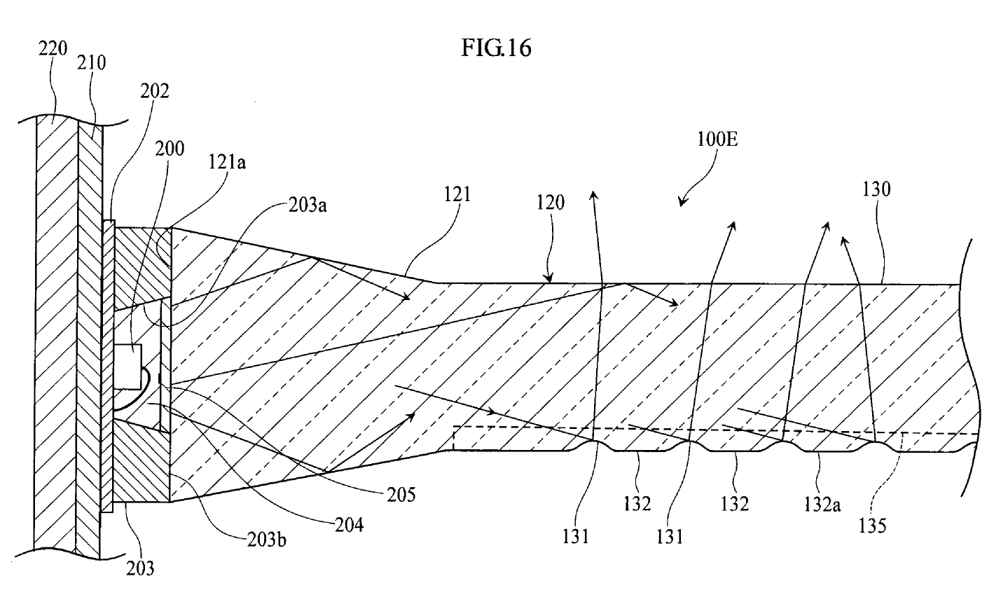

FIGS. 15 and 16 illustrate a linear light source apparatus 100E according to a sixth embodiment of the present invention. The linear light source apparatus 100E includes a light guide member 120 and a light emitting element 200 arranged at each end of the light guide member 120.

As shown in FIG. 15, the light guide member 120 includes a cylindrical main body 130 having a uniform circular cross section throughout the length, and a first end 121 and a second end 122 formed on the main body 130. Each of the first end 121 and the second end 122 has a circular cross section which is continuous with the main body 130 and is so tapered that the diameter gradually increases as proceeding toward the end surface 121a or 122a. The light guide member 120 is molded as a single-piece member by using a transparent resin such as PMMA or polycarbonate, and the circumferential surface is a smooth mirror surface. The substantially cylindrical main body 130 has a diameter of e.g. about 2 mm. The end surfaces 121a and 122a of the first end 121 and the second end 122 have a diameter of e.g. about 4 mm.

As better shown in FIGS. 15 and 16, the circumferential surface of the main body 130 includes a strip-shaped region 134 having a predetermined width and extending in the longitudinal direction of the main body 130. The strip-shaped region 134 is formed with a plurality of recesses 131 and projections 132 arranged alternately and continuously in the longitudinal direction. The upper surface 132a of each of the projections 132 is flat. Each of the recesses 131 has a uniform cross section and extends in the width direction of the strip-shaped region 134. The bottom of each recess 131 is defined by a cylindrical inner surface, and the recess 131 is connected to the upper surface 132a of the projection 132 via a smooth cylindrical surface portion. The strip-shaped region 134 is flanked by flat portions 135 extending along the entire length of the strip-shaped region on two sides of the strip-shaped region which are spaced in the width direction. The flat portions 135 on the sides of the strip-shaped region 134 extend within a same plane and in parallel to the axis of the main body 13. While the diameter of the main body 130 is e.g. 2 mm as described before, the width of the strip-shaped region 134 is e.g. 0.8 mm, the width of each flat portion 135 is e.g. 0.175 mm, the height of the projections 132 relative to the flat portions 135 is e.g. 0.13 mm, the depth of the recesses 131 relative to the upper surface 132a of the projections 132 is e.g. 0.12 mm. The arrangement pitch of the recesses 131 is e.g. 1.5 mm. These dimensions can be varied depending on the diameter of the light guide member 120.

As described before, the light guide member 120 is molded as a single-piece member by using a resin such as PMMA or polycarbonate. Specifically, resin in a fluid state is injected into a cavity defined by a plurality of mold members (see reference signs 500A and 500B in FIG. 5) through a gate 136. After the resin is solidified, the mold is opened. As shown in FIG. 15, the gate 136 is formed in the light guide member 120 substantially at the center of the main body 130 in the longitudinal direction. With respect to the circumferential direction of the main body 130, the gate 136 is provided at a position which avoids the strip-shaped region 134 formed with recesses 131 and projections 132 and a light emitting region facing the strip-shaped region 134. Specifically, the position of the gate 136 is deviated from the center of the width of the strip-shaped region 134 by substantially 90 degrees in the circumferential direction of the main body 130.

As each of the light emitting elements 200, use is made of a package-type LED. As shown in FIG. 16, the light emitting element 200 is bonded to an auxiliary substrate 202. The auxiliary substrate 202 is fixed to a substrate 210. A frame-shaped reflection member 203 including a through-hole 230a for accommodating the light emitting element 200 is fixed to the auxiliary substrate 202. Preferably, the frame-shaped reflection member 203 is made of a white resin. The through-hole 203a is circular. The through-hole 203 is filled with soft resin 204 such as silicone resin so that the light emitting element 200 is covered with the resin. The light emitting element 200 may be designed to emit blue light. In this case, a fluorescent material 205 is arranged to cover the soft resin 204 at the entrance of the through-hole 203a. With this arrangement, the light emitted from the light emitting element 200 is converted into white light. The upper surface 203b (the surface on the light emission side) of the frame-shaped reflection member 203 is flat. The opening of the through-hole 203a at the surface 203b on the light emission side serves as a light emission region of the light emitting element 200. The size of the light emission region is smaller than that of the end surface 121a, 122a of the first end 121 or the second end 122 of the light guide member 120.

As shown in FIG. 16, each of the ends 121 and 122 of the light guide member 120 is bonded to a respective one of the surfaces 203b on the light emission side of the frame-shaped reflection member 203 by using e.g. an adhesive. The light emission region (the through-hole 203a) of the light emitting element 200 is defined within the area of the end surface 121a, 122a of the ends 121, 122.

Each of the substrates 210 may be in the form of an elongated rectangle, and the light emitting element 200 is mounted at an end in the longitudinal direction. The other portions of the substrate are utilized for heat dissipation and arrangement of a wiring pattern. Preferably, the substrate 210 is made of e.g. aluminum nitride. In this embodiment, to promote heat dissipation from the substrate 210, a heat dissipation plate 220 made of aluminum or aluminum alloy and having a predetermined thickness is bonded to the reverse surface of the substrate 210. Preferably, a layer having a high surface thermal radiation rate is further formed on an exposed surface of the heat dissipation plate 220. The layer may be formed by coloring with a black paint, surface treatment called “GHA processing” provided by SANKEI SEIKI CO., LTD, coating of the exposed surface with a ceramic material having a high thermal radiation rate or bonding of a sheet made of a material having a high thermal radiation rate.

The advantages of the linear light source apparatus 100E having the above-described structure are described below.

When the light emitting element 200 is turned on at each of the two ends 121 and 122 of the light guide member 120, the light emitted from the light emitting element 200 impinges on the end surfaces 121a and 122a of the first end 121 and the second end 122 of the light guide member 120 to be guided into the main body 130 (see FIG. 16). Since the light emission region (the through-hole 203a) of each light emitting element 200 is defined within the area of the end surface 121a, 122a of the end 121, 122, all of the light emitted from the light emitting element 200 is guided into the light guide member 120. The ends 121 and 122 of the light guide member 120 are tapered toward the inner side in the longitudinal direction, and the circumferential surfaces are smooth mirror surfaces. Thus, the tapered ends 121 and 122 guide the light into the main body 130 without leaking the light to the outside. Further, since the frame-shaped reflection member 203 of the light emitting element 200 is made of a white resin, the light emitted from the light emitting element 200 is utilized efficiently without being wasted.

As schematically shown in FIG. 16, the light guided into the main body 130 in this way travels in the main body 130 in the longitudinal direction while being totally reflected at the smooth surface. As shown in FIG. 16, part of the light is reflected at the recesses 131, and hence, changes the travel direction to a direction crossing the main body 130. The recesses 131 extend straight in the width direction of the strip-shaped region 134. Thus, the light reflected at the recesses 131 travels to cross the main body 130 without spreading. As schematically shown in FIG. 3, after changing the travel direction, the light travels in the main body 130 substantially toward a region facing the strip-shaped region 134 formed with the recesses 131 and the projections 132. Of the light, the light rays which impinge on the circumferential surface of this region of the main body 130 at an angle smaller than the critical angle for total reflection are emitted to the outside. The convex lens effect is provided by the substantially cylindrical shape of the main body 130, i.e., the fact that the main body 130 has a cylindrical circumferential surface except at the strip-shaped region 134 (the region formed with the recesses 131 and the projections 132) and the flat portions 135 on each side. Thus, the light is prevented from spreading in the circumferential direction of the main body 130 in exiting, so that the emitting light converges on a target region.

The strip-shaped region 134 of the main body 130, which is formed with the recesses 131 and the projections 132, is formed to be sandwiched between flat portions 135. Thus, although the main body 130 has a substantially cylindrical outer configuration, it is easy to make the width of the strip-shaped region 134 uniform throughout the length of the main body 130. Thus, when the light traveling in the longitudinal direction of the light guide member 120 changes the travel direction and exits the light guide member from the circumferential surface facing the strip-shaped region 134, the light is emitted uniformly from every point of the main body 130 in the longitudinal direction.

FIG. 17 shows a linear light source apparatus F according to a seventh embodiment of the present invention. The linear light source apparatus 100F differs from the linear light source apparatus 100E in that a light emitting element 200 is arranged at an end (first end) 121 of the light guide member 120 and a reflector 250 is arranged at the other end (second end) 122 of the light guide member. As to the linear light source apparatus 100F, only the portions which are different from those of the linear light source apparatus 100E are described below. The portions which are identical or similar to those of the linear light source apparatus 100E are designated by the same reference signs, and the description is omitted appropriately.

The arrangement of this embodiment includes a single light emitting element 200, which is arranged to face the first end 121 of the main body 130 of the light guide member 120. The reflector 250 is provided at the second end 122. The reflector 250 may be provided by fitting a cap 252 made of a resin which is white or close to white to the second end 122 of the main body 130 or by vapor deposition of a metal. Alternatively, as described with reference to FIG. 7, the reflector may be provided by cutting the second end 122 of the light guide member 120 into a triangular mountain made up of two surfaces inclined 45 degrees with respect to the axis of the main body 130. Alternatively, the reflector may be provided by cutting the second end into a conical or pyramidal shape of which generatrix or ridge line is inclined about 45 degrees with respect to the axis of the main body. With this arrangement, a large proportion of the light traveling in the main body 130 in the axial direction is totally reflected twice by the inclined surfaces 253 of the second end 122 to return. The returning light further changes the travel direction due to the reflection at the recesses 131 and the projections 132 in the strip-shaped region 134, and hence, is utilized efficiently as emitting light.

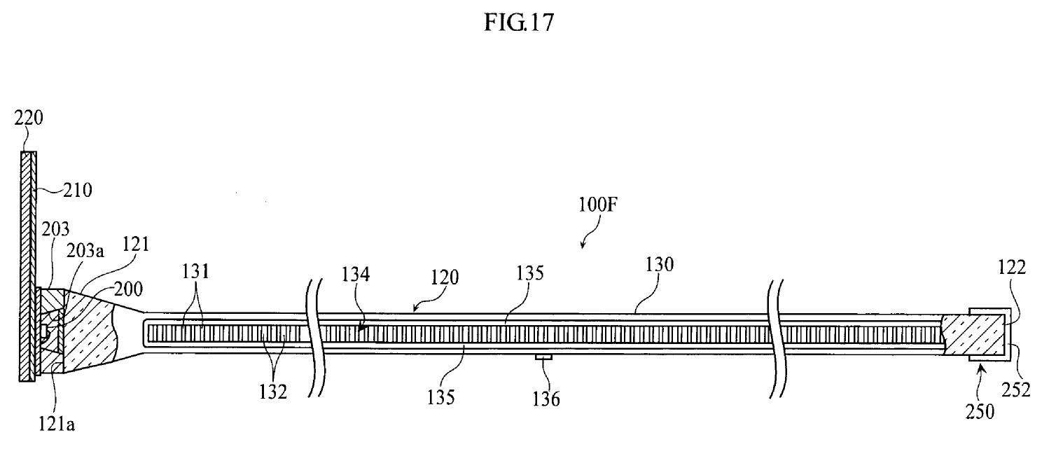

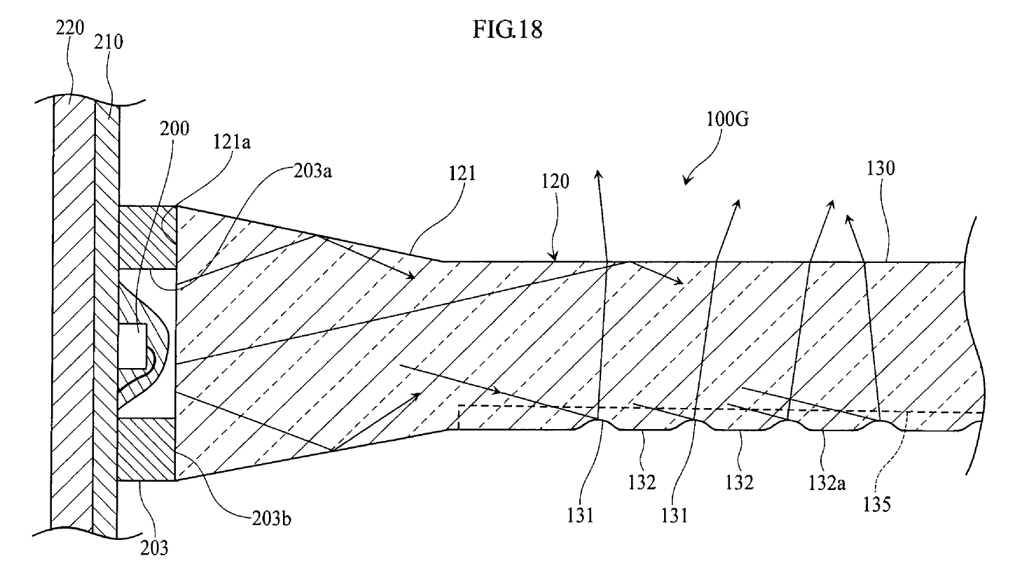

FIG. 18 shows a linear light source apparatus according to an eighth embodiment of the present invention. The linear light source apparatus 100G differs from the linear light source apparatus 100E in that the light emitting element 200 is directly bonded to the substrate 210 and that the frame-shaped reflection member 203 including a through-hole 203a for accommodating the light emitting element 200 is fixed to the substrate 210. As to the linear light source apparatus 100G, only the portions which are different from those of the linear light source apparatus 100E are described below. The portions which are identical or similar to those of the linear light source apparatus 100E are designated by the same reference signs, and the description is omitted appropriately.

The substrate 210 is made of aluminum nitride, and a heat dissipation plate 220 is laminated on a surface of the substrate. The substrate 210 is formed with a bonding pad, on which the light emitting element 200 is directly bonded. The terminal on the top surface of the light emitting element 200 is connected to an electrode pattern formed on the substrate 210 via a wire.

A frame-shaped reflection member 203 including a through-hole 203a for accommodating the light emitting element 200 is fixed to the substrate 210. The through-hole 203a may be circular. Preferably, the frame-shaped reflection member 203 is made of a resin which is white or close to white.

In this embodiment again, each of the first and the second ends 121 and 122 of the light guide member 120, which is tapered, is fixed to a surface on the light emission side of the frame-shaped reflection member 203. In this arrangement again, the through-hole 203a of frame-shaped reflection member 203 is defined within the area of the end surface 121a, 122a of the ends 121, 122 of the light guide member 120.

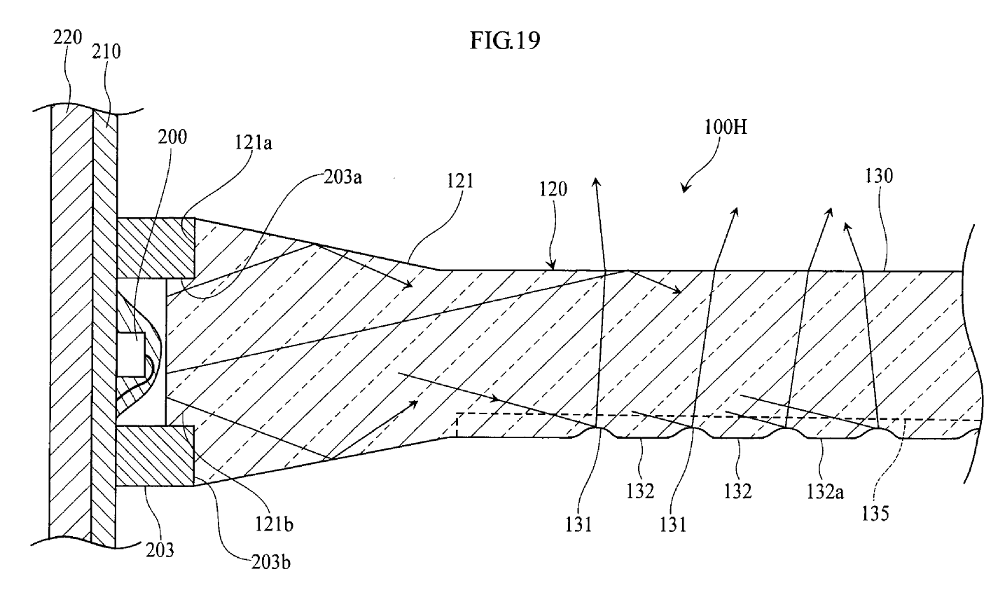

FIG. 19 shows a linear light source apparatus H according to a ninth embodiment of the present invention. The arrangement shown in the figure is substantially the same as that shown in FIG. 18 but differs in that the end surfaces 121a, 122a of the first and the second tapered ends 121 and 122 of the light guide member 120 are respectively formed with cylindrical projections 121b and 122b to be fitted into through-holes 203a of the frame-shaped reflection members 203. With this arrangement, with the projections 121b and 122b fitted in the through-holes 203a of the frame-shaped reflection members 203, the end surfaces 121a and 122a of the first and the second ends 121, 122 are bonded to the upper surfaces 203b of the frame-shaped reflection member 203 by using e.g. an adhesive. Thus, the light guide member 230 is reliably connected to the frame-shaped reflection members 203, with the orientation in a direction perpendicular to the axis set properly. Further, with the projections 121b and 122b inserted in the through-holes 203a, the light guide member 120 can be turned through a desired angle to adjust the light emission direction from the main body 130, which is advantageous.

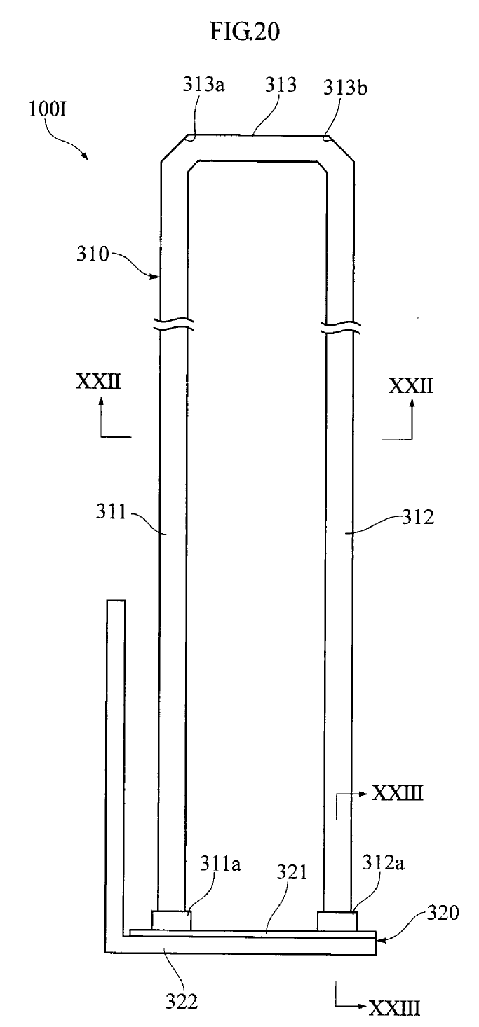

FIGS. 20-23 show a linear light source apparatus 100I according to a tenth embodiment of the present invention. The linear light source apparatus 100I includes a U-shaped light guide member 310 and an LED unit 320.

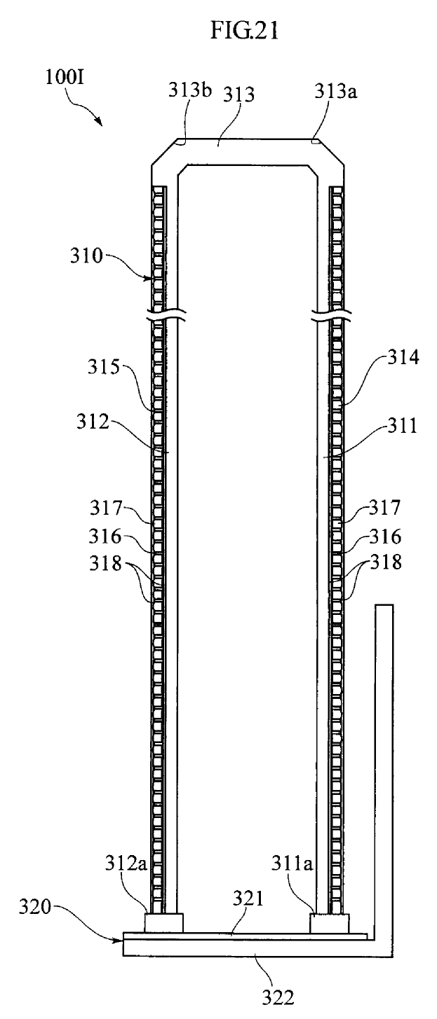

The light guide member 310 is molded as a single-piece member by using a transparent resin such as PMMA or polycarbonate, and has a circumferential surface made as a smooth mirror surface. The light guide member 310 includes a first straight portion 311, a second straight portion 312, a connection portion 313 connecting the two straight portions 311 and 312 to each other, a first reflection region 314 and a second reflection region 315. The straight portions 311 and 312 extend in parallel to each other at a predetermined distance and have a cylindrical shape having a substantially circular cross section. One end of each of the straight portions 311 and 312 is connected to the connection portion 313. The other end of the first straight portion 311 is integrally formed with a first angular socket portion 311a. The other end of the second straight portion 312 is integrally formed with a second angular socket portion 312a. The socket portions 311a and 132a are connected to the LED unit 320. Each of the socket portions 311a and 312a includes a recess 319 having a bottom surface extending perpendicularly to the axis of the straight portion 311, 312. As shown in FIGS. 20 and 21, the connection portion 313 includes a first and a second reflection portions 313a and 313b respectively crossing the central axes of the straight portions 311 and 312 at an angle of 45°. The diameter of the cross section of the straight portions 311, 312 and the connection portion 313 is e.g. about 4 mm.

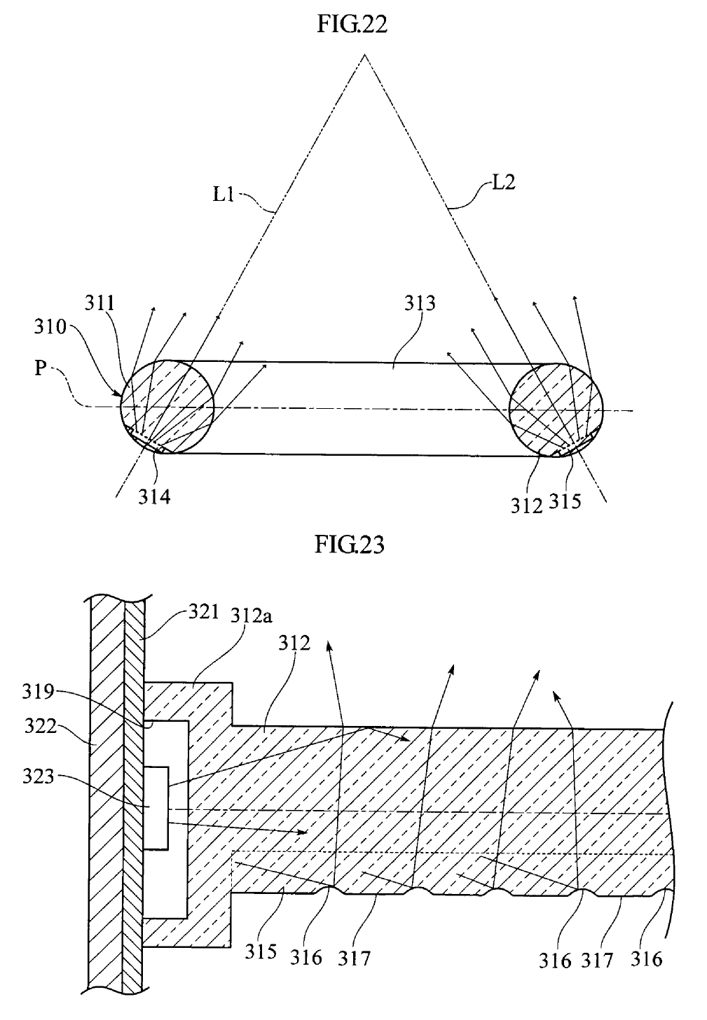

The reflection regions 314 and 315 are provided at the circumferential surfaces of the straight portions 311 and 312 and in the form of a strip having a predetermined width and extending in the longitudinal direction of the straight portions 311 and 312. As shown in FIG. 22, the reflection regions 314 and 315 are provided on the lower side of the reference plane P including the central axes of the first straight portion 311 and the second straight portion 312. In FIG. 22, the reference sign L1 indicates a straight line passing through the center of the width of the first reflection region 314 and the center of the cross section of the first straight portion 311. Similarly, the reference sign L2 indicates a straight line passing through the center of the width of the second reflection region 315 and the center of the cross section of the second straight portion 312. The straight lines L1 and L2 are so inclined as to come close to each other as proceeding upward in FIG. 22. The reflection regions 314 and 315 have the same structure, although the direction of inclination is different. Specifically, as shown in FIG. 21, each of the reflection regions 314 and 315 includes recesses 316 and projections 317 alternately arranged in parallel in the longitudinal direction, and a pair of flat portions 318 extending along the entire length of the reflection region 314, 315 to sandwich the recesses 136 and the projections 317. As shown in FIG. 23, the bottom of each recess 131 is a cylindrical inner surface, and each projection 317 has a flat surface smoothly connected to the recess 316. The paired flat portions 318 extend within a same plane and in parallel to the central axis of the straight portion 311, 312.

The width of reflection regions 314 and 315 is e.g. 1.6 mm, the width of each flat portion 318 is e.g. 0.35 mm, the height of the projections 317 relative to the flat portions 318 is e.g. 0.19 mm, and the depth of the recesses 316 relative to the flat surface of the projections 317 is e.g. 0.18 mm. The arrangement pitch of the recesses 316 is e.g. 1.5 mm. These dimensions can be varied depending on the diameter of the straight portions 311, 312. Although the recesses 316 and the projections 317 extend in the width direction of the reflection regions 314 and 315 to have a uniform cross section in the illustrated example, spherical recesses or projections may be partially provided.

The LED unit 320 includes a substrate 321, a heat dissipation plate 322 and two LEDs 323. The substrate 321 is in the form of an elongated rectangle, and the LEDs 323 are mounted at two ends of the substrate which are spaced in the longitudinal direction (see FIG. 23). The other portions of the substrate are utilized for heat dissipation and arrangement of a wiring pattern. The substrate 210 may be made of aluminum nitride. As shown in FIG. 20, the heat dissipation plate 322 is L-shaped and bonded to the reverse surface of the substrate 321. The heat dissipation plate 322 is made of aluminum or aluminum alloy. Each of the LEDs 323 is accommodated in the recess 319 of the socket portion 31a or 312a so that the light emitting surface faces the bottom surface of the recess 319. As the LED 323, use may be made of a package-type white LED. Alternatively, however, LED bare chips of red, green and blue may be employed.

The light guide member 310 and the LED unit 320 are connected together by bonding the socket portions 311a, 312a and the substrate 321 to each other.

The advantages of the linear light source apparatus 100I are described below.

In the linear light source apparatus 100I, the light emitted from each LED 323 enters the straight portion 311, 312 through the bottom surface of the recess 319. As schematically shown in FIG. 23, the light entering the straight portion 311, 312 travels in the straight portion 311, 312 in the longitudinal direction while being totally reflected at the smooth surface. Part of the light is reflected at the recesses 316, and hence, changes the travel direction to a direction crossing the straight portion 311, 312. As shown in FIG. 22, after changing the travel direction, the light travels toward a region of the straight portion 311, 312 which faces the reflection region 314, 315. Of the light, the light rays which impinge on the circumferential surface of the straight portion 311, 312 at an angle smaller than the critical angle for total reflection are emitted to the outside. Since the straight portion 311, 312 is substantially cylindrical and the circumferential surface is a convex surface, the light is prevented from spreading in the circumferential direction of the straight portion 311, 312 in exiting. Thus, as shown in FIG. 22, the light emitted from the straight portion 311, 312 converges on the intersection point of the straight lines L1 and L2.

The reflection regions 314 and 315 of the linear light source apparatus 100I extend in the longitudinal direction of the straight portions 311 and 312. Thus, the region at which the light rays emitted from the straight portions 311 and 312 intersect and which is hence illuminated brightly also extends straight in the longitudinal direction of the straight portions 311 and 312. Thus, in the linear light source apparatus 100I, a linear illumination target is illuminated from two directions just by turning on the two LEDs 323. Thus, as shown in FIG. 25, illumination is performed properly even when the document D includes creases or wrinkles.

Since the linear light source apparatus 100I produces linear illumination light just by turning on the two LEDs 323, the apparatus is driven with a smaller power than a conventional linear light source apparatus 100I such as cold-cathode tubes or halogen lamps. Moreover, since a high voltage is not necessary for the driving, a booster or the like does not need to be provided in the power supply circuit, which leads to a reduction in cost. Unlike cold-cathode tubes or halogen lamps, the linear light source apparatus 100I does not use mercury vapor in the apparatus.

Since the substrate 321 is made of aluminum nitride and the heat dissipation plate 322 has an L-shaped cross section to have a relatively large surface area, the heat generated in driving the LEDs 323 is quickly dissipated. Since the two LEDs 323 are mounted on the same substrate 321, the heat dissipation effect is obtained by the use of a single heat dissipation plate 322.

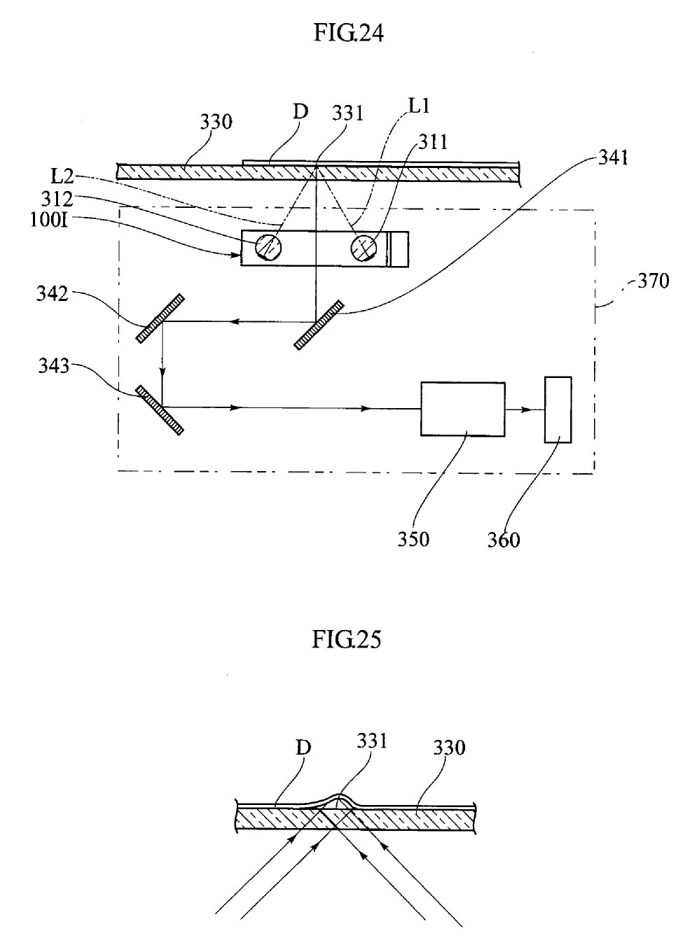

FIG. 24 is a sectional view schematically showing the structure of an image reading apparatus incorporating the linear light source apparatus 100I. The image reading apparatus includes a transparent document supporting plate 330, reflecting mirrors 341, 342, 343, an image forming lens 350, a line sensor 360 and a housing 370, in addition to the linear light source apparatus 100I. The housing 370 accommodates the linear light source apparatus 100I, the reflecting mirrors 341, 342, 343, the image forming lens 350 and the line sensor 360. The housing 370 is movable relative to the document supporting plate 330 in the left and right direction in FIG. 24.

The line sensor 360, which may be a CCD, includes a plurality of pixel portions aligned at a predetermined pixel pitch. The line sensor reads the document D at a reading region 331 extending linearly in the direction perpendicular to the sheet surface of FIG. 24. As shown in the figure, the light reflected by the document D at the reading region 331 is successively reflected by the reflecting mirrors 341, 342, 343 to impinge on the line sensor 360 via the image forming lens 350. By translating the housing 370 in the right and left direction, the image reading apparatus reads the entirety of the document D. The linear light source apparatus 100I is so arranged in the image reading apparatus that the intersection point of the straight lines L1 and L2 corresponds to the reading region 331. Thus, the light rays emitted from the straight portions 311 and 312 of the linear light source apparatus 100I travel along the straight lines L1 and L2, respectively, to illuminate the reading region 331 from two directions.

1. A linear light source apparatus comprising:
a light guide member made of resin and including a columnar main body elongate in a longitudinal direction and a first and a second ends at two ends of the main body, the main body comprising a circumferential surface including a smooth mirror surface and formed with a plurality of recesses or projections arranged in the longitudinal direction in a predetermined area in a circumferential direction of the main body; and
a light emitting element arranged to face the first end, wherein:
light emitted from the light emitting element and entering the first end is emitted from a predetermined region of the circumferential surface of the main body along the length thereof, the region facing the area in which the recesses or the projections are formed; and
the circumferential surface of the main body includes a strip-shaped region having a predetermined width and extending in the longitudinal direction of the main body, the recesses or projections are formed in the strip-shaped region and extend straight in the width direction of the strip-shaped region.

2. The linear light source apparatus according to claim 1, wherein a flat portion having a predetermined width is formed on each of two sides of the strip-shaped region that are spaced in the width direction.

3. The linear light source apparatus according to claim 2, wherein the circumferential surface of the main body comprises an outer surface of a cylinder or an elliptic cylinder except at the strip-shaped region and the flat portions.

4. The linear light source apparatus according to claim 2, wherein the circumferential surface of the main body is formed with a mold gate of the light guide member in a region excluding the strip-shaped region, the flat portions and a region facing the strip-shaped region.

5. The linear light source apparatus according to claim 4, further comprising an additional light emitting element arranged to face the second end, wherein the gate is positioned at a center of the main body in the longitudinal direction.

6. The linear light source apparatus according to claim 4, wherein the gate is formed at a position which is deviated from the region formed with the recesses or the projections by substantially 90 degrees in the circumferential direction.

7. The linear light source apparatus according to claim 1, further comprising a substrate to which the light emitting element is mounted and a frame-shaped connection member fixed to the substrate, wherein the frame-shaped connection member includes a through-hole accommodating the light emitting element, and part of the through-hole receives the first end.

8. The linear light source apparatus according to claim 7, wherein the through-hole of the frame-shaped connection member includes a stepped portion for engagement with an end surface of the first end.

9. The linear light source apparatus according to claim 7, wherein a portion of the first end that is received in the through-hole includes a cylindrical outer surface.

10. The linear light source apparatus according to claim 7, wherein the substrate is made of a material having high heat conductivity.

11. The linear light source apparatus according to claim 10, wherein the material having high heat conductivity includes aluminum nitride.

12. The linear light source apparatus according to claim 11, further comprising a heat dissipation member made of aluminum or aluminum alloy and bonded to the substrate.

13. The linear light source apparatus according to claim 12, further comprising a cover layer having a heat dissipation function and formed on an exposed surface of the heat dissipation member.

14. The linear light source apparatus according to claim 1, further comprising a substrate to which the light emitting element is mounted and a frame-shaped connection member fixed to the substrate, wherein the frame-shaped connection member includes a through-hole accommodating the light emitting element, and the first end of the light guide member is bonded to the frame-shaped connection member to close the through-hole.

15. The linear light source apparatus according to claim 14, wherein the first end is tapered in a direction to be away from the frame-shaped connection member.

16. The linear light source apparatus according to claim 14, wherein the connection member is made of an opaque material which is white or close to white.

17. A linear light source apparatus comprising:
a light guide member including a first and a second cylindrical straight portions extending in parallel to each other at a predetermined distance, and a connection portion connecting the first and the second straight portions to each other; and
a light emitting unit arranged to face ends of the first and the second straight portions, wherein:
the first straight portion includes a circumferential surface that includes a first reflection region in form of a strip formed with a plurality of recesses or projections, whereas the second straight portion includes a circumferential surface that includes a second reflection region in form of a strip formed with a plurality of recesses or projections, both of the first and the second reflection regions being positioned on one side of a reference plane that includes respective axes of the first and the second straight portions; and
in a cross section of the first and the second straight portions, a first straight line extending from a center of the first reflection region through the axis of the first straight portion and a second straight line extending from a center of the second reflection region through the axis of the second straight portion intersect at a point.

18. The linear light source apparatus according to claim 17, wherein the light emitting unit includes two LEDs facing an end of the first straight portion and an end of the second straight portion, respectively, and a substrate to which both of the LEDs are mounted.

19. The linear light source apparatus according to claim 18, further comprising a heat dissipation plate held in contact with the substrate, wherein the substrate is made of aluminum nitride, whereas the heat dissipation plate is made of aluminum or aluminum alloy.

20. An image reading apparatus comprising:
a light source apparatus for illuminating a linearly extending image reading region; and
an image sensor for detecting light from the image reading region;
wherein the light source apparatus is a linear light source apparatus as set forth in claim 17.
